(19) United States
(12) Patent Application Publication
(10) Pub. No.: US 2026/0295572 A1
(43) Pub. Date: Oct. 1, 2026

(54) PILLAR-SHAPED HONEYCOMB STRUCTURE

(71) Applicant: NGK INSULATORS, LTD., Nagoya-shi (JP)

(72) Inventors: Daiki SUZUKI, Okazaki-shi (JP); Sho EIJIMA, Novi, MI (US); Koji MOTOKI, Jiangsu (CN)

(73) Assignee: NGK INSULATORS, LTD., Nagoya-shi (JP)

(21) Appl. No.: 19/571,805

(22) Filed: Mar. 19, 2026

(30) Foreign Application Priority Data
Mar. 31, 2025 (JP) 2025-059952

(51) Int. Cl. B01J 35/57; B01D 53/94; B01J 23/10; B01J 23/78; B01J 37/02; B01J 37/08

(52) U.S. Cl. CPC B01J 35/57; B01D 53/94; B01J 23/10; B01J 23/78; B01J 37/0215; B01J 37/0236; B01J 37/08; B01D 2255/9155

(57) ABSTRACT

A pillar-shaped honeycomb structure includes an outer peripheral side wall, and a plurality of partition walls disposed on an inner peripheral side of the outer peripheral side wall, partitioning a plurality of cells penetrating from a first end surface to a second end surface and forming flow paths each having an opening at both ends, wherein an average porosity of the plurality of partition walls measured according to a mercury porosimetry method specified in JIS R1655: 2003 is 50 to 60%; and wherein a ratio of a volume occupied by pores having a pore diameter of 6 μm or more to a total pore volume of the plurality of partition walls measured according to the mercury porosimetry method specified in JIS R1655: 2003 is 40% or less.

### CROSS REFERENCE TO RELATED APPLICATIONS

The present invention claims the benefit of priority to Japanese Patent Application No. 2025-59952 filed on Mar. 31, 2025 with the Japanese Patent Office, the entire contents of which are incorporated herein by reference in its entirety.

### FIELD OF THE INVENTION

The present invention is related to a pillar-shaped honeycomb structure. In particular, the present invention is related to a pillar-shaped honeycomb structure for exhaust gas purification.

### BACKGROUND OF THE INVENTION

Exhaust gases emitted from internal combustion engines, such as automobile engines, contain pollutants such as soot, nitrogen oxides (NOX), soluble organic fractions (SOF), hydrocarbons (HC), and carbon monoxide (CO). For this reason, it is common practice to install a pillar-shaped honeycomb structure supporting an appropriate catalyst (oxidation catalyst, reduction catalyst, three-way catalyst, and the like) depending on the pollutant in the exhaust gas system of an internal combustion engine to purify the exhaust gas.

A pillar-shaped honeycomb structure includes an outer peripheral side wall, and a plurality of porous partition walls disposed on the inner peripheral side of the outer peripheral side wall and partitioning a plurality of cells that form flow paths from a first end surface to a second end surface. A catalyst layer containing the above-mentioned catalyst can be formed on the surface of the porous partition walls.

In recent years, progress has been made in the development of a pillar-shaped honeycomb structure that can raise the temperature of a catalyst layer to an activation temperature in a short time after starting an engine. In order to raise the temperature of the catalyst layer to the activation temperature in a short time, it is necessary to reduce the weight of the pillar-shaped honeycomb structure. That is, it is necessary to reduce the heat capacity of the partition walls by thinning the partition walls or increasing the porosity. In this way, the temperature of the partition walls can be raised in a short time after the exhaust gas starts to flow, and the temperature of the catalyst layer formed on the surface of the partition walls can be raised to the activation temperature in a short time. However, since there is a limit to how thin the partition walls can be made, increasing the porosity is considered as a method for reducing the weight. Under such circumstances, there is a concern that the strength of the pillar-shaped honeycomb structure may be reduced.

Under this background, Patent Literature 1 describes an invention that aims to achieve practically satisfactory compressive strength characteristics, even though the partition walls are thin, by satisfying certain conditions between the wall thickness of the partition walls and the open frontal area and/or bulk density of the honeycomb structure.

In addition, Patent Literature 2 describes an invention that aims to provide a pillar-shaped honeycomb structure having a partition wall structure that is suitable for achieving both light weight and high strength by controlling the maximum and minimum values of porosity for each partition wall when measured in the thickness direction from one surface to the other using an X-ray microscope. Patent Literature 2 also discloses that the average pore diameter of the partition walls measured with a mercury porosimeter is 10 μm or less, that when the porosity (%) of each partition wall is measured in the thickness direction from one surface to the other surface, the average porosity of each partition wall is 40 to 70%, and that the difference between the maximum and minimum porosity values in each partition wall is 11% or less.

However, when the average porosity is high, there is a problem that the catalyst tends to penetrate into the partition walls when it is applied. If the catalyst penetrates into the cell walls, the exhaust gas and the catalyst will not come into contact, and the desired purification performance may not be achieved. Accordingly, Patent Literature 3 describes an invention in which the average porosity of the partition walls constituting a pillar-shaped honeycomb structure is increased to reduce weight while ensuring high strength, and the porosity of the partition wall surface, where stress is likely to occur, is locally reduced and the average pore diameter is further reduced in order to suppress catalyst penetration into the partition walls.

### PRIOR ART

### Patent Literature

[Patent Literature 1] Japanese Patent Application Publication No. H7-39761
[Patent Literature 2] Japanese Patent Application Publication No. 2023-151174
[Patent Literature 3] Japanese Patent Application Publication No. 2023-151167

### SUMMARY OF THE INVENTION

As described above, technological developments have been made to reduce the weight and increase the strength of pillar-shaped honeycomb structures. Recently, in addition to these issues, there has been an added challenge of preventing catalyst from penetrating into the partition walls, making the technological development of pillar-shaped honeycomb structures more difficult. The thinnest cell wall currently available on the market is 0.05 mm, and since it is difficult to make the partition walls thinner than this, the only way to reduce the weight is to increase the porosity. Therefore, how to prevent the catalyst from penetrating into the partition walls while increasing the porosity has become an issue.

The invention described in Patent Literature 3 also attempts to improve the prevention of catalyst penetration into the partition walls, but there is still room for improvement. In the invention described in Patent Literature 3, the porosity is reduced from the surface of the partition wall to a depth of 5% to suppress the infiltration, but the pore size that directly affects the infiltration of catalyst is not clarified. The present invention has been made in consideration of the above circumstances, and an object of one embodiment of the present invention is to provide a pillar-shaped honeycomb structure that has high porosity and can effectively suppress the penetration of catalyst into the partition walls.

The present inventors have conducted extensive research to solve the above problems, and have found that, for the partition walls constituting the pillar-shaped honeycomb structure, to suppress the penetration of catalyst into the partition walls while increasing the average porosity to reduce weight, it is more important to reduce the ratio of the volume occupied by pores of 6 μm or more to the total pore volume of the partition walls, rather than to control the average pore diameter. The present invention, which was completed based on this finding, is exemplified as below.

### [Aspect 1]

A pillar-shaped honeycomb structure, comprising an outer peripheral side wall, and a plurality of partition walls disposed on an inner peripheral side of the outer peripheral side wall, partitioning a plurality of cells penetrating from a first end surface to a second end surface and forming flow paths each having an opening at both ends,
wherein an average porosity of the plurality of partition walls measured according to a mercury porosimetry method specified in JIS R1655: 2003 is 50 to 60%; and
wherein a ratio of a volume occupied by pores having a pore diameter of 6 μm or more to a total pore volume of the plurality of partition walls measured according to the mercury porosimetry method specified in JIS R1655: 2003 is 40% or less.

### [Aspect 2]

The pillar-shaped honeycomb structure according to aspect 1, wherein a ratio of the volume occupied by pores having a pore diameter of 6 to 7 μm to the total pore volume of the plurality of partition walls measured according to the mercury porosimetry method specified in JIS R1655: 2003 is 10% or less.

### [Aspect 3]

The pillar-shaped honeycomb structure according to aspect 1 or 2, wherein a pore diameter (D50) measured by the mercury porosimetry method specified in JIS R1655: 2003 when 50% of the total pore volume of the plurality of partition walls is intruded by mercury is 5.2 μm or less.

### [Aspect 4]

The pillar-shaped honeycomb structure according to any one of aspects 1 to 3, wherein a pore diameter (D10) measured by the mercury porosimetry method specified in JIS R1655: 2003 when 10% of the total pore volume of the plurality of partition walls is intruded by mercury is 2.7 μm or less.

### [Aspect 5]

The pillar-shaped honeycomb structure according to any one of aspects 1 to 4, wherein a pore diameter (D90) measured by the mercury porosimetry method specified in JIS R1655: 2003 when 90% of the total pore volume of the plurality of partition walls is intruded by mercury is 13.1 μm or less.

### [Aspect 6]

The pillar-shaped honeycomb structure according to aspect 1 or 2, wherein a pore diameter (D50) measured by the mercury porosimetry method specified in JIS R1655: 2003 when 50% of the total pore volume of the plurality of partition walls is intruded by mercury is 5.2 μm or less;
wherein a pore diameter (D10) measured by the mercury porosimetry method specified in JIS R1655: 2003 when 10% of the total pore volume of the plurality of partition walls is intruded by mercury is 2.7 μm or less; and
wherein a pore diameter (D90) measured by the mercury porosimetry method specified in JIS R1655: 2003 when 90% of the total pore volume of the plurality of partition walls is intruded by mercury is 13.1 μm or less.

### [Aspect 7]

The pillar-shaped honeycomb structure according to any one of aspects 1 to 6, wherein a pore volume occupied by pores having a pore diameter of 6 μm or more in the plurality of partition walls measured by the mercury porosimetry method specified in JIS R1655: 2003 is 0.14 cc/g or less.

### [Aspect 8]

The pillar-shaped honeycomb structure according to any one of aspects 1 to 7, wherein a pore volume occupied by pores having a pore diameter of 6 to 7 μm in the plurality of partition walls measured by the mercury porosimetry method specified in JIS R1655: 2003 is 0.050 cc/g or less.

### [Aspect 9]

The pillar-shaped honeycomb structure according to any one of aspects 1 to 8, wherein an average thickness of the plurality of partition walls is 50 to 150 μm.

### [Aspect 10]

The pillar-shaped honeycomb structure according to any one of aspects 1 to 9, wherein the plurality of partition walls is formed of ceramics comprising 90% by mass or more of cordierite.

### [Aspect 11]

The pillar-shaped honeycomb structure according to any one of aspects 1 to 10, further comprising a catalyst layer on a surface of the plurality of partition walls.

According to one embodiment of the present invention, there is provided a pillar-shaped honeycomb structure that has a high porosity and can effectively suppress the penetration of catalyst into the interior of the partition walls. As a result, for example, by using the pillar-shaped honeycomb structure as a catalyst carrier, it becomes possible to exhibit the function of raising the catalyst temperature to an activation temperature in a short period of time. In addition, since the catalyst supported on the partition walls does not easily penetrate into the interior of the partition walls, the catalyst can be used efficiently.

### BRIEF DESCRIPTION OF THE DRAWINGS

FIG. 1 is a perspective view schematically showing a pillar-shaped honeycomb formed body.

FIG. 2 is a schematic cross-sectional view of a pillar-shaped honeycomb formed body when observed from a direction perpendicular to the direction in which the cells extend.

FIG. 3 is a schematic enlarged partial view of a pillar-shaped honeycomb structure when observed in a cross section perpendicular to the direction in which the cells extend.

FIG. 4 is a graph showing the correlation between the pore size of the partition walls and the catalyst penetration suppression effect.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### <1. Pillar-Shaped Honeycomb Structure>

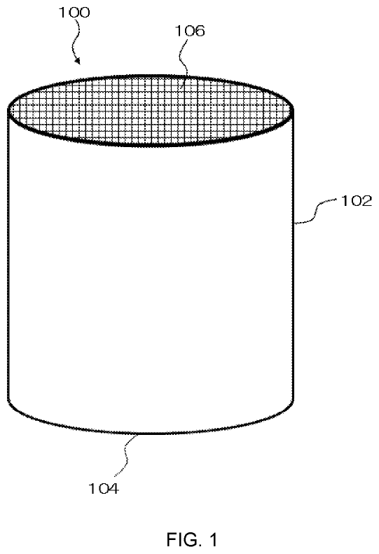

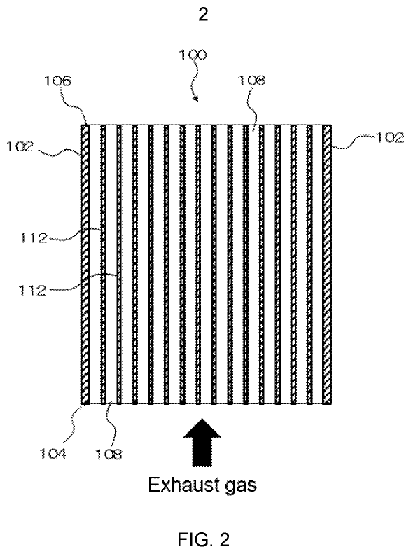

FIGS. 1 and 2 are a schematic perspective view and a cross-sectional view, respectively, of a pillar-shaped honeycomb structure 100 that can be used as a catalyst carrier in an automobile exhaust gas purification system. This pillar-shaped honeycomb structure 100 comprises an outer peripheral side wall 102 and a plurality of partition walls 112 disposed on the inner peripheral side of the outer peripheral side wall 102. The plurality of partition walls 112 partition a plurality of cells 108 penetrating from a first end surface 104 to a second end surface 106 and forming flow paths having openings at both ends. In this pillar-shaped honeycomb structure 100, exhaust gas that has flowed into one cell 108 from the first end surface 104 is purified while passing through the cell, and then flows out from the second end surface 106.

There are no restrictions on the shape of the end surfaces of the pillar-shaped honeycomb structure 100, but it can be, for example, a round shape such as a circle, an ellipse, a racetrack shape, or an oval shape, a polygonal shape such as a triangle or a quadrangle, or other irregular shapes. The illustrated pillar-shaped honeycomb structure 100 has circular end surfaces and is cylindrical as a whole.

There is no particular limitation on the height of the pillar-shaped honeycomb structure (the length from the first end surface to the second end surface), and it may be set appropriately depending on the application and required performance. There is no particular limitation on the relationship between the height of the pillar-shaped honeycomb structure and the maximum diameter of each end surface (the maximum length of the diameters passing through the center of gravity of each end surface of the pillar-shaped honeycomb structure). Therefore, the height of the pillar-shaped honeycomb structure may be longer than the maximum diameter of each end surface, or the height of the pillar-shaped honeycomb structure may be shorter than the maximum diameter of each end surface.

The material for forming the partition walls and outer peripheral side walls of the pillar-shaped honeycomb structure is not limited, but ceramics can be mentioned. As ceramics, mention can be made to cordierite, mullite, zirconium phosphate, aluminum titanate, silicon carbide (SiC), silicon-silicon carbide composites (e.g., Si-bonded SiC), cordierite-silicon carbide composites, zirconia, spinel, indialite, sapphirine, corundum, titania, silicon nitride, and the like. In addition, for the ceramics, one type may be contained alone, or two or more types may be contained simultaneously.

In a preferred embodiment, the partition walls are made of ceramics comprising 90% by mass or more of cordierite. This means that the total mass ratio of cordierite (2MgO·2Al₂O₃·5SiO₂) in 100% by mass of the material constituting the partition walls is 90% by mass or more. The mass ratio of cordierite in 100% by mass of the material constituting the partition walls is more preferably 95% by mass or more, and even more preferably 99% by mass or more. It is also possible that, other than unavoidable impurities, 100% by mass of the material constituting the partition walls is cordierite.

The content of cordierite can be measured by X-ray diffraction. Specifically, an X-ray diffraction apparatus using Cu Kα rays (for example, an X'pert PRO apparatus manufactured by PANalytical) is used to perform X-ray analysis measurement in the range of 2θ=8 to 100° by X-ray diffraction on a sample of the outer peripheral side wall, partition wall, or sealing portion, and analysis is performed using the Rietveld analysis program RIETAN to measure the cordierite crystalline phase ratio, which is taken as the content of the cordierite.

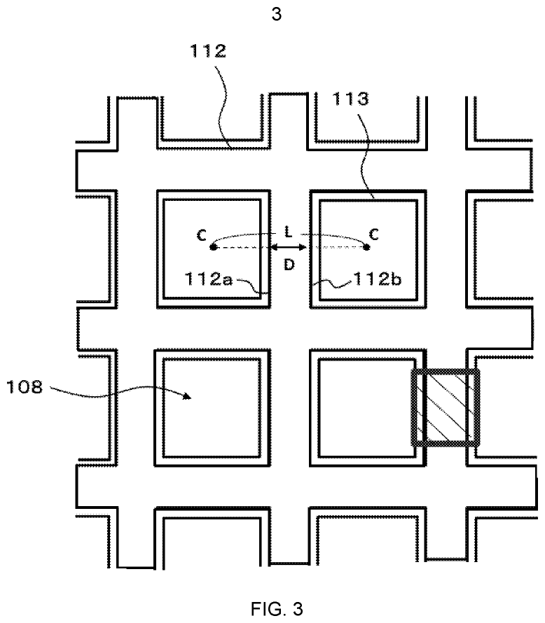

The lower limit of the average thickness of the partition walls in the pillar-shaped honeycomb structure is preferably 50 μm or more, more preferably 60 μm or more, and even more preferably 70 μm or more, from the viewpoint of ensuring strength. In addition, the upper limit of the average thickness of the partition walls is preferably 150 μm or less, more preferably 130 μm or less, and even more preferably 100 μm or less, from the viewpoint of suppressing pressure loss. Therefore, the average thickness of the partition walls is, for example, preferably 50 to 150 μm, more preferably 60 to 130 μm, and even more preferably 70 to 100 μm. FIG. 3 shows a schematic enlarged partial view of the partition walls 112 of the pillar-shaped honeycomb structure 100 when observed in a cross section perpendicular to the direction in which the cells 108 extend. As used herein, the thickness of the partition wall refers to a crossing length D of a line segment L that crosses the partition wall when the centers of gravity C of adjacent cells are connected by this line segment L in a cross-section orthogonal to the direction in which the cells extend. The average thickness of the partition walls refers to the average value of the thicknesses of all the partition walls.

In the pillar-shaped honeycomb structure, the partition walls may be porous. The lower limit of the average pore size of the partition walls of the pillar-shaped honeycomb structure is preferably 3 μm or more from the viewpoint of carrying catalyst. In addition, the upper limit of the average pore size of the partition walls is preferably 10 μm or less, more preferably 8 μm or less, and even more preferably 6 μm or less, from the viewpoint of preventing the catalyst from penetrating into the interior of the partition walls. Therefore, the average pore size of the partition walls is, for example, preferably 3 to 10 μm, more preferably 3 to 8 μm, and even more preferably 3 to 6 μm.

From the viewpoint of achieving weight reduction and suppressing an increase in pressure loss, the lower limit of the average porosity of the partition walls is preferably 50% or more, and more preferably 54% or more. In addition, from the viewpoint of ensuring the strength of the pillar-shaped honeycomb structure, the upper limit of the average porosity of the partition walls is preferably 60% or less, and more preferably 56% or less. Therefore, the average porosity of the partition walls is preferably, for example, 50 to 60%, and more preferably 54 to 56%. As used herein, “porosity” is measured by the mercury porosimetry method specified in JIS R1655: 2003. In addition, the average porosity is determined by collecting partition wall samples (0.3 g each) uniformly from six locations on the pillar-shaped honeycomb structure and calculating the porosity of each sample, and the average value is used as the measured value.

From the viewpoint of suppressing the penetration of the catalyst into the interior of the partition walls, it is effective to control the ratio of the volume occupied by pores having a pore diameter of 6 μm or more to the total pore volume of the partition walls. Specifically, the ratio of the volume occupied by the pores having a pore diameter of 6 μm or more to the total pore volume of the partition wall measured according to the mercury porosimetry method specified in JIS R1655: 2003 (hereinafter also referred to as “volume ratio occupied by the pores having a pore diameter of 6 μm or more”) is preferably 40% or less, more preferably 30% or less, and even more preferably 20% or less. There is no particular lower limit set for the volume ratio occupied by the pores having a pore diameter of 6 μm or more, but from the viewpoint of carrying catalyst, it is preferably 5% or more, and typically 10% or more. Therefore, the volume ratio occupied by the pores having a pore diameter of 6 μm or more is, for example, preferably 5 to 40%, more preferably 5 to 30%, even more preferably 5 to 20%, and typically 10 to 40%.

Further, the pore volume occupied by the pores having a pore diameter of 6 μm or more in the plurality of partition walls is preferably 0.14 cc/g or less, more preferably 0.11 cc/g or less, and even more preferably 0.08 cc/g or less. Although no particular lower limit is set for the pore volume occupied by the pores having a pore diameter of 6 μm or more in the plurality of partition walls, from the viewpoint of carrying catalyst, it is preferably 0.02 cc/g or more, and typically 0.04 cc/g or more. Therefore, the volume ratio occupied by the pores having a pore diameter of 6 μm or more in the plurality of partition walls is, for example, preferably 0.02 to 0.14 cc/g, more preferably 0.04 to 0.11 cc/g, and even more preferably 0.04 to 0.08 cc/g. The volume ratio occupied by the pores having a pore diameter of 6 μm or more is measured by the mercury porosimetry method specified in JIS R1655: 2003.

Even among the pores having a pore diameter of 6 μm or more, by controlling the ratio of the volume occupied by pores having a pore diameter of 6 to 7 μm to the total pore volume of the partition walls, penetration of the catalyst into the partition walls can be effectively suppressed. Specifically, the ratio of the volume occupied by the pores having a pore diameter of 6 to 7 μm to the total pore volume of the partition walls measured according to the mercury porosimetry method specified in JIS R1655: 2003 (hereinafter also referred to as “volume ratio occupied by the pores having a pore diameter of 6 to 7 μm”) is preferably 10% or less, more preferably 8% or less, and even more preferably 6% or less. There is no particular lower limit set for the volume ratio occupied by the pores having a pore diameter of 6 to 7 μm, but from the viewpoint of carrying catalyst, it is preferably 3% or more, and typically 4% or more. Therefore, the volume ratio of the pores having a pore diameter of 6 to 7 μm is, for example, preferably 3 to 10%, more preferably 3 to 8%, even more preferably 3 to 6%, and typically 4 to 10%.

Further, the pore volume occupied by the pores having a pore diameter of 6 to 7 μm in the plurality of partition walls is preferably 0.050 cc/g or less, more preferably 0.040 cc/g or less, and even more preferably 0.030 cc/g or less. Although no particular lower limit is set for the pore volume occupied by the pores having a pore diameter of 6 to 7 μm in the plurality of partition walls, from the viewpoint of carrying catalyst, it is preferably 0.005 cc/g or more, and typically 0.010 cc/g or more. Therefore, the volume ratio of the pores having a pore diameter of 6 to 7 μm in the plurality of partition walls is, for example, preferably 0.005 to 0.050 cc/g, more preferably 0.010 to 0.040 cc/g, and even more preferably 0.010 to 0.030 cc/g. The volume ratio of the pores occupied by the pores having a pore diameter of 6 to 7 μm is measured by the mercury porosimetry method specified in JIS R1655: 2003.

Furthermore, in addition to controlling the volume ratio occupied by the pores having a pore diameter of 6 μm or more and the volume ratio occupied by the pores having a pore diameter of 6 to 7 μm, it is preferable to control the D10, D50 and D90 of the pore diameters of the partition walls.

Specifically, the pore diameter (D50) measured by the mercury porosimetry method specified in JIS R1655: 2003 when 50% of the total pore volume of the plurality of partition walls is intruded by mercury, is preferably 5.2 μm or less, more preferably 4.8 μm or less, and even more preferably 4.4 μm or less, from the viewpoint of preventing catalyst penetration into the interior of the partition wall. In addition, although no particular lower limit is set for D50, from the viewpoint of carrying catalyst, it is preferably 2 μm or more, typically 4 μm or more. Therefore, D50 is, for example, preferably 2 to 5.2 μm, more preferably 2 to 4.8 μm, even more preferably 2 to 4.4 μm, and typically 4 to 5.2 μm.

The pore diameter (D10) measured by the mercury porosimetry method specified in JIS R1655: 2003 when 10% of the total pore volume of the plurality of partition walls is intruded by mercury, is preferably 2.7 μm or less, more preferably 2.5 μm or less, and even more preferably 2.3 μm or less, from the viewpoint of preventing catalyst penetration into the interior of the partition walls. In addition, although no particular lower limit is set for D10, from the viewpoint of carrying catalyst, it is preferably 1 μm or more, typically 2 μm or more. Therefore, D10 is, for example, preferably 1 to 2.7 μm, more preferably 1 to 2.5 μm, even more preferably 1 to 2.3 μm, and typically 2 to 2.3 μm.

The pore diameter (D90) measured by the mercury porosimetry method specified in JIS R1655: 2003 when 90% of the total pore volume of the plurality of partition walls is intruded by mercury, is preferably 13.1 μm or less, more preferably 10.6 μm or less, and even more preferably 8.1 μm or less, from the viewpoint of preventing catalyst penetration into the interior of the partition wall. In addition, although there is no particular lower limit for D90, it is preferably 7 μm or more from the viewpoint of carrying catalyst. Therefore, D90 is preferably, for example, 7 to 13.1 μm, more preferably 7 to 10.6 μm, and even more preferably 7 to 8.1 μm.

The mercury porosimetry method specified in JIS R1655: 2003 is a method in which a mercury porosimeter is used to apply a uniform pressure to a sample immersed in mercury under vacuum, and mercury is forced into the sample while the pressure is gradually increased, and the pore size distribution is calculated from the pressure and the volume of mercury intruded into the pores. As the pressure is gradually increased, mercury is intruded into the pores starting from the larger diameter pores, increasing the cumulative volume of mercury, and when all the pores are finally filled with mercury, the cumulative volume reaches an equilibrium amount. The cumulative volume at this time is the total pore volume (cm³/g), and the pore diameters when mercury volumes of 10%, 50%, and 90% of the total pore volume have been intruded are D10, D50, and D90, respectively. Further, it is also possible to calculate the pore volume in a given pore diameter range using a mercury porosimeter.

Six partition wall samples (0.3 g) are collected uniformly from the pillar-shaped honeycomb structure, and the pore size distribution of each sample is measured to determine the volume ratio occupied by the pores having a pore diameter of 6 μm or more, the volume ratio occupied by the pores having a pore diameter of 6 to 7 μm, D10, D50, and D90, and the average values were taken as the measured values.

There are no limitations on the shape of the cell opening in a cross section perpendicular to the direction in which the cells extend, but it is preferably a quadrangle, a hexagon, an octagon, or a combination thereof. Among these, square and hexagonal shapes are preferred. By using such cell opening shapes, pressure loss when exhaust gas flows through the honeycomb structure is reduced. Further, by forming the opening shape of the cells in this way, the pressure loss when a fluid is passed through the pillar-shaped honeycomb structure is reduced, and the purification performance of the catalyst is improved.

There is no particular limitation on the cell density (number of cells per unit cross-sectional area) of the pillar-shaped honeycomb structure, and it can be, for example, 6 to 2000 cells/square inch (0.9 to 311 cells/cm²), more preferably 50 to 1000 cells/square inch (7.8 to 155 cells/cm²), and particularly preferably 100 to 900 cells/square inch (15.5 to 139 cells/cm²). Here, the cell density is calculated by dividing the number of cells in the pillar-shaped honeycomb structure by the area of one end surface of the pillar-shaped honeycomb structure excluding the outer peripheral side wall.

Referring again to FIG. 3, when the pillar-shaped honeycomb structure 100 is used as a catalyst carrier, a catalyst layer 113 can be provided on the surface of the partition wall 112 depending on the purpose. As the catalyst, though not limited thereto, mention can be made to oxidation catalysts (DOCs) for oxidatively burning hydrocarbons (HC) and carbon monoxide (CO) to increase the exhaust gas temperature, PM combustion catalysts for assisting in the combustion of PM such as soot, SCR catalysts and NSR catalysts for removing nitrogen oxides (NOx), and three-way catalysts capable of simultaneously removing hydrocarbons (HC), carbon monoxide (CO), and nitrogen oxides (NOx). The catalyst may contain, as appropriate, for example, noble metals (Pt, Pd, Rh, and the like), alkali metals (Li, Na, K, Cs, and the like), alkaline earth metals (Mg, Ca, Ba, Sr, and the like), rare earths (Ce, Sm, Gd, Nd, Y, La, Pr, and the like), transition metals (Mn, Fe, Co, Ni, Cu, Zn, Sc, Ti, Zr, V, Cr, and the like), and the like.

### <2. Manufacturing Method of Pillar-Shaped Honeycomb Structure>

A method for manufacturing a pillar-shaped honeycomb structure will be described below as an example. First, a raw material composition containing ceramic raw materials, a dispersion medium, a pore-forming material, and a binder is kneaded to prepare a green body, and then the green body is extrusion molded and dried to produce a pillar-shaped honeycomb formed body. Additives such as dispersants can be blended into the raw material composition as needed. In the extrusion molding, a die having a desired overall shape, cell shape, partition wall thickness, cell density, and the like can be used.

In the drying step, a conventionally known drying method such as hot gas drying, microwave drying, dielectric drying, reduced pressure drying, vacuum drying, freeze drying, and the like can be used. Among these, a drying method that combines hot gas drying with microwave drying or dielectric drying is preferred, since it allows the entire formed body to be dried quickly and uniformly. Sealing portions can be formed by forming the sealing portions at predetermined positions on both end surfaces of the dried honeycomb formed body and then drying the sealing portions.

The ceramic raw material is a raw material of a portion that remains after firing of metal oxides, metals, and the like, and that constitutes the skeleton of a pillar-shaped honeycomb formed body (pillar-shaped honeycomb structure) after firing as ceramics. The ceramic raw material may be provided, for example, in the form of a powder. As the ceramic raw material, mention can be made to raw materials for obtaining ceramics such as cordierite, mullite, zircon, aluminum titanate, silicon carbide, silicon nitride, zirconia, spinel, indialite, sapphirine, corundum, and titania. Specific examples include, but are not limited to, silica, talc, alumina, kaolin, serpentine, pyroferrite, brucite, boehmite, mullite, magnesite, aluminum hydroxide, and the like. The ceramic raw material may be used singly or in combination of two or more kinds.

Cordierite can be suitably used as the ceramic. In this case, a cordierite-forming raw material can be used as the ceramic raw material. The cordierite-forming raw material is a raw material that becomes cordierite when fired. It is desirable that the cordierite raw material have a chemical composition of 30 to 45% by mass of alumina (Al₂O₃) (including aluminum hydroxide that converts to alumina), 11 to 17% by mass of magnesia (MgO), and 42 to 57% by mass of silica (SiO₂).

Examples of the dispersion medium include water and a mixed solvent of water and an organic solvent such as alcohol, with water being particularly preferred.

The pore-forming material is not particularly limited as long as it forms pores after firing, and examples thereof include wheat flour, starch, foamed resin, water-absorbent resin, silica gel, carbon (for example, graphite, coke), ceramic balloons, polyethylene, polystyrene, polypropylene, nylon, polyester, acrylic, and phenol. As the pore-forming material, one type may be used alone, or two or more types may be used in combination. From the viewpoint of increasing the porosity of the honeycomb structure, the content of the pore-forming material is preferably 0.5 parts by mass or more, more preferably 2 parts by mass or more, and even more preferably 3 parts by mass or more, with respect to 100 parts by mass of the ceramic raw material. From the viewpoint of ensuring the strength of the honeycomb structure, the content of the pore-forming material is preferably 12 parts by mass or less, more preferably 10 parts by mass or less, and even more preferably 7 parts by mass or less, with respect to 100 parts by mass of the ceramic raw material.

As a method for reducing the volume ratio occupied by the pores having a pore diameter of 6 μm or more, and further the volume ratio occupied by the pores having a pore diameter of 6 to 7 μm, to the total pore volume of the partition walls, a method for adjusting the sizes and addition amounts of silica and a pore-forming material in the ceramic raw material can be mentioned. Specifically, it is preferable to satisfy the following three conditions.

(Condition 1) The median diameter (D50) of the silica is greater than 5 μm and smaller than 10 μm.

(Condition 2) A value obtained by multiplying the median diameter (μm) of silica by the percentage (%) of the parts by mass of silica with respect to 100 parts by mass of the ceramic raw material is greater than 100 (μm·%) and less than 200 (μm·%).

(Condition 3) A value obtained by multiplying the square of the median diameter (μm) of the pore-forming material by the percentage (%) of the parts by mass of the pore-forming material with respect to 100 parts by mass of the ceramic raw material is smaller than 1600 (μm²·%)

Here, the median diameter (D50) of the silica and the pore-forming agent is a volume-based value measured by a laser diffraction/scattering particle size distribution measuring device.

When two or more types of silica and/or pore-forming material are used, the average value is used for condition 1. For condition 2, the sum of the values obtained for each silica is used. For condition 3, the sum of the values obtained for each pore-forming material is used.

For example, when silica A, silica B, pore-forming material A, pore-forming material B, and pore-forming material C are used under the conditions shown in Table 1 below, condition 1, condition 2, and condition 3 are expressed by the following formulas.

TABLE 1

| | | | Pore-forming | Pore-forming | Pore-forming |
|---|---|---|---|---|---|
| | Silica A | Silica B | material A | material B | material C |
| Median diameter | D50_{(Silica A)} | D50_{(Silica B)} | D50_{(Pore-forming material A)} | D50_{(Pore-forming material B)} | D50_{(Pore-forming material C)} |
| D50 (μm) | | | | | |
| Mass concentration (%) | INPUT_{(Silica A)} | INPUT_{(Silica B)} | INPUT_{(Pore-forming material A)} | INPUT_{(Pore-forming material B)} | INPUT_{(Pore-forming material C)} |

$$10 > \{ {D 50}_{( Silica A )} \times {INPUT}_{( Silica A )} + {D 50}_{( Silica B )} \times {INPUT}_{( Silica B )} \} / \{ {INPUT}_{( Silica A )} + {INPUT}_{( Silica B )} \} > 5 \qquad ( Condition 1 )$$

$$200 > {D 50}_{( Silica A )} \times {INPUT}_{( Silica A )} + {D 50}_{( Silica B )} \times {INPUT}_{( Silica B )} > 100 \qquad ( Condition 2 )$$

$${( {D 50}_{( Pore - forming material A )} )}^{2} \times {INPUT}_{( Pore - forming material A )} + {( {D 50}_{( Pore - forming material B )} )}^{2} \times {INPUT}_{( Pore - forming material B )} + {( {D 50}_{( Pore - forming material C )} )}^{2} \times {INPUT}_{( Pore - forming material C )} < 1600 \qquad ( Condition 3 )$$

In a preferred embodiment, the following conditions 1a, 2a, and 3a are satisfied.

(Condition 1a) The median diameter (D50) of the silica is greater than 5 μm and less than 9 μm.

### (Condition 2a)

A value obtained by multiplying the median diameter (μm) of silica by the percentage (%) of the parts by mass of silica with respect to 100 parts by mass of the ceramic raw material is greater than 100 (μm·%) and less than 180 (μm·%).

### (Condition 3a)

A value obtained by multiplying the square of the median diameter (μm) of the pore-forming material by the percentage (%) of the parts by mass of the pore-forming material with respect to 100 parts by mass of the ceramic raw material is smaller than 1500 (μm²·%)

In a more preferred embodiment, the following conditions 1b, 2b, and 3b are satisfied.

(Condition 1b) The median diameter (D50) of the silica is greater than 5 μm and less than 8 μm.

### (Condition 2b)

A value obtained by multiplying the median diameter (μm) of silica by the percentage (%) of the parts by mass of silica with respect to 100 parts by mass of the ceramic raw material is greater than 100 (μm·%) and less than 160 (μm·%).

### (Condition 3b)

A value obtained by multiplying the square of the median diameter (μm) of the pore-forming material by the percentage (%) of the parts by mass of the pore-forming material with respect to 100 parts by mass of the ceramic raw material is smaller than 1400 (μm²·%)

Examples of the binder include organic binders such as methyl cellulose, hydroxypropyl methyl cellulose, hydroxyethyl cellulose, carboxymethyl cellulose, and polyvinyl alcohol. In particular, it is preferable to use methylcellulose and hydroxypropylmethylcellulose in combination. In addition, from the viewpoint of increasing the strength of the honeycomb formed body before firing, the content of the binder is preferably 4 parts by mass or more, more preferably 5 parts by mass or more, and even more preferably 6 parts by mass or more, with respect to 100 parts by mass of the ceramic raw material. From the viewpoint of suppressing cracks due to abnormal heat generation during the firing process, the content of the binder is preferably 9 parts by mass or less, more preferably 8 parts by mass or less, and even more preferably 7 parts by mass or less, with respect to 100 parts by mass of the ceramic raw material. As the binder, one type may be used alone, and two or more types may be used in combination.

As the dispersant, ethylene glycol, dextrin, fatty acid soap, polyether polyol, and the like can be used. As the dispersant, one type may be used alone, and two or more types may be used in combination. The content of the dispersant is preferably 0 to 2 parts by mass with respect to 100 parts by mass of the ceramic raw material.

The dried pillar-shaped honeycomb formed body is subjected to a degreasing step and a firing step, whereby a pillar-shaped honeycomb structure can be manufactured. The conditions for the degreasing step and the firing step may be any known conditions that correspond to the material composition of the honeycomb formed body, and no particular explanation is required, but specific examples of the conditions are listed below.

The degreasing process will be explained. The combustion temperature of the binder is about 200° C., and the combustion temperature of the pore-forming material is about 300 to 1000° C. Therefore, the degreasing step may be carried out by heating the honeycomb formed body to a temperature in the range of about 200 to 1000° C. The heating time is not particularly limited, but is usually about 10 to 100 hours. The honeycomb formed body after the degreasing step is called a calcined body.

The firing step may be carried out by, for example, heating the calcined body to 1350 to 1600° C. in the air atmosphere and holding the calcined body for 3 to 10 hours, depending on the material composition of the honeycomb formed body.

### Examples

### (1. Manufacture of Honeycomb Structure: Test Nos. 1 to 16)

According to the test number, the cordierite-forming raw material, pore-forming material A, pore-forming material B, pore-forming material C, binder, dispersant, and dispersion medium were added in the formulation ratios shown in Table 2, and mixed and kneaded to prepare a green body. Talc, kaolin, alumina, aluminum hydroxide, silica A, and silica B were used as the cordierite-forming raw material. Silica A and silica B had different median diameters (D50). Pore-forming materials A, B, and C also had different median diameters (D50). Water was used as the dispersion medium, a polyacrylic acid polymer was used as the pore former, hydroxypropylmethylcellulose was used as the binder, and fatty acid soap was used as the dispersant. In addition, the median diameter (D50) of each material listed in Table 2 is a volume-based value measured using a laser diffraction/scattering particle size distribution measuring device (Model LA960 manufactured by Horiba, Ltd.).

For silica A, silica B, pore-forming material A, pore-forming material B, and pore-forming material C, the values of the following three formulas are shown in Table 2.

$$\{ {D 50}_{( Silica A )} \times {INPUT}_{( Silica A )} + {D 50}_{( Silica B )} \times {INPUT}_{( Silica B )} \} / \{ {INPUT}_{( Silica A )} + {INPUT}_{( Silica B )} \} \qquad Formula 1$$

$${D 50}_{( Silica A )} \times {INPUT}_{( Silica A )} + {D 50}_{( Silica B )} \times {INPUT}_{( Silica B )} \qquad Formula 2$$

$${( {D 50}_{( Pore - forming material A )} )}^{2} \times {INPUT}_{( Pore - forming material A )} + {( {D 50}_{( Pore - forming material B )} )}^{2} \times {INPUT}_{( Pore - forming material B )} + {( {D 50}_{( Pore - forming material C )} )}^{2} \times {INPUT}_{( Pore - forming material C )} ) \qquad Formula 3$$

This green body was charged into an extrusion molding machine and extrusion molded in the horizontal direction through a predetermined die to obtain a cylindrical honeycomb formed body. The obtained honeycomb formed body was subjected to dielectric drying and hot gas drying, and then both end surfaces were cut to a predetermined size to obtain a cylindrical honeycomb formed body.

The obtained cylindrical honeycomb formed body was degreased by heating at 200° C. for 8 hours in the air atmosphere, and then fired at 1430° C. for 4 hours in the air atmosphere to obtain a cylindrical honeycomb structure. The pillar-shaped honeycomb structures according to the respective test examples were manufactured in the number required to evaluate the following properties. The specifications of the obtained pillar-shaped honeycomb structure were as follows.
Overall shape: Cylindrical, 118.4 mm diameter×112.0 mm height
Cell shape in cross section perpendicular to the cell flow direction: Square
Cell density (number of cells per unit cross-sectional area): 900 cells/cm²
Average partition wall thickness: 64 μm (nominal value based on the die specifications)
Cordierite content: 90% by mass or more

### (2. Property Evaluation)

The honeycomb structures obtained above were subjected to various property evaluations.

### [2-1. Pore Characteristics of Partition Walls]

The average porosity and pore size distribution of the partition walls were measured according to the above-mentioned measurement method using an Autopore 9505 manufactured by Micrometrics Co. The results are shown in Table 2.

### [2-2. Evaluation of Catalyst Penetration Suppression Effect]

The catalyst penetration suppression effect was evaluated by the following procedure. First, a catalyst slurry containing an alumina-ceria-zirconia composite oxide having a median diameter of 3 to 7 μm was prepared. The catalyst was carried onto the honeycomb structure by washcoating, in which the catalyst slurry was poured into the upper end surface of the honeycomb structure and sucked in from the lower end surface, and a predetermined amount of catalyst (170 g per 1 L of the external dimension of the honeycomb structure) was carried onto the partition walls of the honeycomb structure. Thereafter, the honeycomb filter carrying the catalyst was dried with hot gas at 120° C. and further subjected to heat treatment at 550° C. for 1 hour to obtain a honeycomb structure with catalyst.

Two samples of the partition walls were taken from the center of the honeycomb structure with catalyst, and the cross section of a straight portion perpendicular to the direction in which the cells extend (hatched portion in FIG. 3) was observed at 250× magnification using an SEM. For the obtained SEM image, image analysis software Winroof 2018 Standard ver. 4.0.1 was used to distinguish and calculate the areas of the catalyst portion and the substrate portion based on the color shade, and the catalyst penetration rate was determined by the following equation: catalyst penetration rate=area of catalyst portion that has penetrated into the partition walls/(area of catalyst portion that has penetrated into the partition walls+area of catalyst portion that covers the partition walls)×100(%). The average value of the measurements for two samples was used as the measured value. The results are shown in Table 2.

TABLE 2

| | | Example | | | | | | | |
|---|---|---|---|---|---|---|---|---|---|
| | Test No. | 1 | 2 | 3 | 4 | 5 | 6 | 7 | 8 |
| Green body | Talc (D50 = 10 μm) | 40 | 40 | 40 | 40 | 40 | 40 | 40 | 40 |
| formulation | Kaolin (D50 = 5 μm) | 0 | 0 | 0 | 0 | 0 | 0 | 0 | 0 |
| ratios | Alumina (D50 = 5 μm) | 15 | 15 | 15 | 15 | 15 | 15 | 15 | 10 |
| (parts | Aluminum hydroxide | 25 | 25 | 25 | 25 | 25 | 25 | 25 | 30 |
| by mass) | (D50 = 3 μm) | | | | | | | | |
| | Silica A (D50 = 5 μm) | 15 | 15 | 15 | 15 | 15 | 15 | 10 | 15 |
| | Silica B (D50 = 10 μm) | 5 | 5 | 5 | 5 | 5 | 5 | 10 | 5 |
| | Pore-forming material A | 2.5 | 1.5 | 2.5 | 3.5 | 2 | 0.5 | 3 | 2.5 |
| | (D50 = 10 μm) | | | | | | | | |
| | Pore-forming material B | 0 | 3 | 5 | 0 | 8 | 10 | 0 | 5 |
| | (D50 = 12 μm) | | | | | | | | |
| | Pore-forming material C | 2.5 | 1.5 | 0 | 0 | 0 | 0 | 0 | 0 |
| | (D50 = 22 μm) | | | | | | | | |
| | Binder | 8 | 8 | 8 | 8 | 8 | 8 | 8 | 8 |
| | Dispersant | 1 | 1 | 1 | 1 | 1 | 1 | 1 | 1 |
| | Dispersion medium | 65 | 55 | 55 | 60 | 60 | 50 | 65 | 55 |
| Value of Formula 1 | | 6.25 | 6.25 | 6.25 | 6.25 | 6.25 | 6.25 | 7.5 | 6.25 |
| Value of Formula 2 | | 125 | 125 | 125 | 125 | 125 | 125 | 150 | 125 |
| Value of Formula 3 | | 1460 | 1308 | 970 | 350 | 1352 | 1490 | 300 | 970 |
| Partition | Average Porosity (%) | 54.9 | 54.4 | 55.4 | 54.3 | 54.5 | 56.2 | 55.8 | 55.7 |
| wall | Volume percentage occupied | 19.1 | 15.4 | 19.9 | 24.6 | 17.8 | 15.1 | 22.9 | 26.2 |
| properties | by pores with a diameter of | | | | | | | | |
| | 6 μm or more (%) | | | | | | | | |
| | Volume percentage occupied | 4.3 | 4.0 | 6.3 | 8.2 | 5.3 | 4.5 | 7.4 | 9.3 |
| | by pores with a diameter of | | | | | | | | |
| | 6 to 7 μm (%) | | | | | | | | |
| | Volume of pores with a diameter | 0.092 | 0.073 | 0.098 | 0.116 | 0.085 | 0.077 | 0.115 | 0.131 |
| | of 6 μm or more (cc/g) | | | | | | | | |
| | Volume of pores with a diameter | 0.021 | 0.019 | 0.031 | 0.038 | 0.025 | 0.023 | 0.037 | 0.046 |
| | of 6 to 7 μm (cc/g) | | | | | | | | |
| | D10 (μm) | 2.1 | 2.2 | 2.3 | 2.1 | 2.3 | 2.4 | 2.2 | 2.6 |
| | D50 (μm) | 4.1 | 4.0 | 4.5 | 4.6 | 4.3 | 4.3 | 4.6 | 4.8 |
| | D90 (μm) | 10.7 | 7.8 | 8.8 | 9.6 | 8.3 | 7.4 | 9.4 | 9.6 |

| | | | | | | | | |
|---|---|---|---|---|---|---|---|---|
| Catalyst penetration rate (%) | 5.4 | 5.1 | 6.9 | 8.0 | 6.0 | 5.7 | 7.8 | 9.3 |

| | | Comparative Example | | | | | | | |
|---|---|---|---|---|---|---|---|---|---|
| | Test No. | 9 | 10 | 11 | 12 | 13 | 14 | 15 | 16 |
| Green body | Talc (D50 = 10 μm) | 40 | 40 | 40 | 40 | 40 | 40 | 40 | 40 |
| formulation | Kaolin (D50 = 5 μm) | 0 | 0 | 0 | 5 | 40 | 10 | 20 | 10 |
| ratios | Alumina (D50 = 5 μm) | 20 | 15 | 10 | 25 | 10 | 10 | 15 | 15 |
| (parts | Aluminum hydroxide | 20 | 25 | 30 | 10 | 8 | 20 | 15 | 20 |
| by mass) | (D50 = 3 μm) | | | | | | | | |
| | Silica A (D50 = 5 μm) | 15 | 15 | 15 | 18 | 2 | 20 | 10 | 15 |
| | Silica B (D50 = 10 μm) | 5 | 5 | 5 | 2 | 0 | 0 | 0 | 0 |
| | Pore-forming material A | 0 | 0 | 0 | 0 | 0 | 2 | 0 | 0 |
| | (D50 = 10 μm) | | | | | | | | |
| | Pore-forming material B | 0 | 0 | 0 | 0 | 0 | 0 | 0 | 0 |
| | (D50 = 12 μm) | | | | | | | | |
| | Pore-forming material C | 3.5 | 3.5 | 3.5 | 4.2 | 0.5 | 0 | 2.5 | 4.5 |
| | (D50 = 22 μm) | | | | | | | | |
| | Binder | 8 | 8 | 8 | 8 | 8 | 8 | 8 | 8 |
| | Dispersant | 1 | 1 | 1 | 1 | 1 | 1 | 1 | 1 |
| | Dispersion medium | 60 | 60 | 60 | 60 | 30 | 50 | 45 | 60 |
| Value of Formula 1 | | 6.25 | 6.25 | 6.25 | 5.5 | 5 | 5 | 5 | 5 |
| Value of Formula 2 | | 125 | 125 | 125 | 110 | 10 | 100 | 50 | 75 |
| Value of Formula 3 | | 1694 | 694 | 694 | 2032.8 | 242 | 200 | 1210 | 2178 |
| Partition | Average Porosity (%) | 55.0 | 55.0 | 55.1 | 54.6 | 32.7 | 47.0 | 47.5 | 55.2 |
| wall | Volume percentage occupied | 45.1 | 42.1 | 35.8 | 45.0 | 44.3 | 11.9 | 39.2 | 50.0 |
| properties | by pores with a diameter of | | | | | | | | |
| | 6 μm or more (%) | | | | | | | | |
| | Volume percentage occupied | 14.2 | 13.7 | 12.2 | 14.6 | 8.9 | 1.9 | 9.4 | 11.4 |
| | by pores with a diameter of | | | | | | | | |
| | 6 to 7 μm (%) | | | | | | | | |
| | Volume of pores with a diameter | 0.219 | 0.204 | 0.174 | 0.215 | 0.086 | 0.042 | 0.141 | 0.245 |
| | of 6 μm or more (cc/g) | | | | | | | | |
| | Volume of pores with a diameter | 0.069 | 0.066 | 0.059 | 0.070 | 0.017 | 0.007 | 0.034 | 0.056 |
| | of 6 to 7 μm (cc/g) | | | | | | | | |
| | D10 (μm) | 2.8 | 2.7 | 2.4 | 2.9 | 2.9 | 1.8 | 2.7 | 2.1 |
| | D50 (μm) | 5.7 | 5.5 | 5.2 | 5.7 | 5.5 | 3.1 | 5.2 | 6.0 |
| | D90 (μm) | 12.8 | 12.4 | 10.9 | 14.7 | 21.9 | 7.1 | 13.1 | 14.6 |

| | | | | | | | | |
|---|---|---|---|---|---|---|---|---|
| Catalyst penetration rate (%) | 12.6 | 12.3 | 11.2 | 12.8 | 4.2 | 4.5 | 5.7 | 11.7 |

### (3. Discussion)

Comparing test numbers 1 to 12 and 16, which had a porosity of about 55%, it can be seen that test numbers 1 to 8, which were Examples, had a significantly reduced catalyst penetration rate compared to test numbers 9 to 12 and 16, which were Comparative Examples. Test numbers 13 to 15, which were Comparative Examples, had low catalyst penetration rate, but the porosity is low, so they were unable to achieve both weight reduction and low catalyst penetration rate.

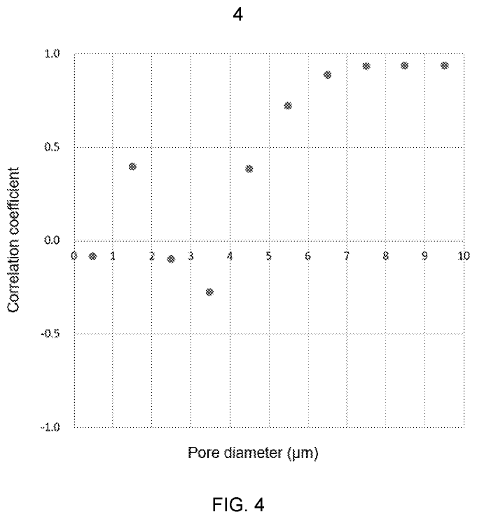

Based on the above test results, the pore diameter was divided into pore diameter intervals of 1 μm in the range of 0 to 10 μm, and the correlation with the catalyst penetration suppression effect was investigated. The results are shown in FIG. 4. It can be seen from FIG. 4 that the correlation coefficient increases significantly when the pore diameter is 6 μm or more. In other words, it can be understood that controlling the volume ratio occupied by pores having a pore diameter of 6 μm or more is important for suppressing catalyst penetration.

### DESCRIPTION OF REFERENCE NUMERALS

100: Pillar-shaped honeycomb structure
102: Outer peripheral side wall
104: First end surface
106: Second end surface
108: Cell
112: Partition wall
113: Catalyst layer

1. A pillar-shaped honeycomb structure, comprising an outer peripheral side wall, and a plurality of partition walls disposed on an inner peripheral side of the outer peripheral side wall, partitioning a plurality of cells penetrating from a first end surface to a second end surface and forming flow paths each having an opening at both ends,
wherein an average porosity of the plurality of partition walls measured according to a mercury porosimetry method specified in JIS R1655: 2003 is 50 to 60%; and
wherein a ratio of a volume occupied by pores having a pore diameter of 6 μm or more to a total pore volume of the plurality of partition walls measured according to the mercury porosimetry method specified in JIS R1655: 2003 is 40% or less.

2. The pillar-shaped honeycomb structure according to claim 1, wherein a ratio of the volume occupied by pores having a pore diameter of 6 to 7 μm to the total pore volume of the plurality of partition walls measured according to the mercury porosimetry method specified in JIS R1655: 2003 is 10% or less.

3. The pillar-shaped honeycomb structure according to claim 1, wherein a pore diameter (D50) measured by the mercury porosimetry method specified in JIS R1655: 2003 when 50% of the total pore volume of the plurality of partition walls is intruded by mercury is 5.2 μm or less.

4. The pillar-shaped honeycomb structure according to claim 1, wherein a pore diameter (D10) measured by the mercury porosimetry method specified in JIS R1655: 2003 when 10% of the total pore volume of the plurality of partition walls is intruded by mercury is 2.7 μm or less.

5. The pillar-shaped honeycomb structure according to claim 1, wherein a pore diameter (D90) measured by the mercury porosimetry method specified in JIS R1655: 2003when 90% of the total pore volume of the plurality of partition walls is intruded by mercury is 13.1 μm or less.

6. The pillar-shaped honeycomb structure according to claim 1, wherein a pore diameter (D50) measured by the mercury porosimetry method specified in JIS R1655: 2003 when 50% of the total pore volume of the plurality of partition walls is intruded by mercury is 5.2 μm or less;
wherein a pore diameter (D10) measured by the mercury porosimetry method specified in JIS R1655: 2003 when 10% of the total pore volume of the plurality of partition walls is intruded by mercury is 2.7 μm or less; and
wherein a pore diameter (D90) measured by the mercury porosimetry method specified in JIS R1655: 2003 when 90% of the total pore volume of the plurality of partition walls is intruded by mercury is 13.1 μm or less.

7. The pillar-shaped honeycomb structure according to claim 1, wherein a pore volume occupied by pores having a pore diameter of 6 μm or more in the plurality of partition walls measured by the mercury porosimetry method specified in JIS R1655: 2003 is 0.14 cc/g or less.

8. The pillar-shaped honeycomb structure according to claim 1, wherein a pore volume occupied by pores having a pore diameter of 6 to 7 μm in the plurality of partition walls measured by the mercury porosimetry method specified in JIS R1655: 2003 is 0.050 cc/g or less.

9. The pillar-shaped honeycomb structure according to claim 1, wherein an average thickness of the plurality of partition walls is 50 to 150 μm.

10. The pillar-shaped honeycomb structure according to claim 1, wherein the plurality of partition walls is formed of ceramics comprising 90% by mass or more of cordierite.

11. The pillar-shaped honeycomb structure according to claim 1, further comprising a catalyst layer on a surface of the plurality of partition walls.
